(19) United States
(12) Patent Application Publication
(10) Pub. No.: US 2020/0379386 A1
(43) Pub. Date: Dec. 3, 2020

(54) FIXING DEVICE AND IMAGE FORMING APPARATUS

(71) Applicant: KYOCERA Document Solutions Inc., Osaka (JP)

(72) Inventors: Tomohiro WATATANI, Osaka-shi (JP); Masakazu UEHARA, Osaka-shi (JP); Hironori TAKAHASHI, Osaka-shi (JP); Yuhiro SAKAI, Osaka-shi (JP); Fumito NAKAMOTO, Osaka-shi (JP)

(73) Assignee: KYOCERA Document Solutions Inc., Osaka (JP)

(21) Appl. No.: 16/887,270

(22) Filed: May 29, 2020

(30) Foreign Application Priority Data
May 31, 2019 (JP) 2019-102278

(51) Int. Cl. G03G 15/20

(52) U.S. Cl. CPC G03G 15/2053; G03G 2215/2035; G03G 15/2064

(57) ABSTRACT

A fixing device includes a fixing belt, a pressure member, and a heating section. The heating section faces an inner circumferential surface of the fixing belt. The heating section includes a heater and a heater holding member. The heater heats the fixing belt. The heater holding member holds the heater. The heater holding member has a first side surface, a second side surface, and an inclined slit. The first and second side surfaces are in contact with the inner circumferential surface. The first side surface has the inclined slit. The inclined slit is located in the first side surface in a direction of a rotational axis of the fixing belt. The inclined slit has one end on a side of the pressure member and the other end on an opposite side to the side of the pressure member. The other end is located nearer a middle (center) of the first side surface in the direction of the rotational axis than the one end.

### INCORPORATION BY REFERENCE

The present application claims priority under 35 U.S.C. § 119 to Japanese Patent Application No. 2019-102278, filed on May 31, 2019. The contents of this application are incorporated herein by reference in their entirety.

### BACKGROUND

The present disclosure relates to a fixing device and an image forming apparatus.

An electrographic image forming apparatus includes a fixing device that fixes a toner image to paper. A fixing device includes a belt, a pressure member, a heat source, a nip forming member, and a heat transfer auxiliary member.

The belt is flexible and has an endless shape. The pressure member faces the belt and passively rotates the belt. The heat source is placed in an inner part of the belt. The nip forming member is placed inside the belt and forms a fixing nip between the belt and the pressure member. The heat transfer auxiliary member covers a surface of the nip forming member facing the belt.

When the belt is rotated by the pressure member, the belt and the nip forming member are rubbed. The belt and the nip forming member are rubbed, thereby generating friction powder. The friction powder mixes with a lubricating oil. The lubricating oil adheres to an inner circumferential surface of the belt. The lubricating oil reduces friction between the belt and the nip forming member. When the friction powder mixes with the lubricating oil, viscosity of the lubricating oil increases. When the viscosity of the lubricating oil increases, lubrication performance of the lubricating oil decreases. When the performance of the lubricating oil decreases, the friction between the belt and the nip forming member increases. Such an increase in the friction between the belt and the nip forming member causes an increase in torque for rotating the belt.

With a second lubricating oil placed inside the belt, the fixing device drops the second lubricating oil on the inner circumferential surface of the belt. The fixing device adds the lubricating oil on the inner circumferential surface of the belt, thereby preventing an increase in viscosity of the lubricating oil and an increase in torque for rotating the belt.

### SUMMARY

A fixing device according to an aspect of the present disclosure includes a fixing belt, a pressure member, and a heating section. The pressure member rotates the fixing belt while applying pressure to an outer circumferential surface of the fixing belt. The heating section faces an inner circumferential surface of the fixing belt. The heating section includes a heater and a heater holding member. The heater heats the fixing belt. The heater holding member holds the heater. The heater holding member includes a first side surface, a second side surface, and an inclined slit. The first and second side surfaces are in contact with the inner circumferential surface. The inclined slit is located in at least one of the first and second side surfaces in a direction of a rotational axis of the fixing belt. The inclined slit has one end on a side of the pressure member and an other end on an opposite side to the side of the pressure member. The other end is located nearer a middle of the fixing belt in the direction of the rotational axis than the one end.

An image forming apparatus according to an aspect of the present disclosure includes the above-described fixing device and an image forming section. The image forming section forms a toner image on a recording medium. The fixing device fixes the toner image to the recording medium.

### BRIEF DESCRIPTION OF THE DRAWINGS

FIG. 1 illustrates an image forming apparatus according to a first embodiment of the present disclosure.

FIG. 2 is a perspective view of main parts of a fixing device of the image forming apparatus according to the first embodiment of the present disclosure.

FIG. 3 is a cross-sectional view of the fixing device taken along a line III-III of FIG. 2.

FIG. 4 is a perspective view of the fixing device depicted in FIG. 2 with a fixing belt thereof omitted.

FIG. 5 illustrates the fixing device depicted in FIG. 4, as seen from a positive side of a Z axis.

FIG. 6 illustrates the fixing device depicted in FIG. 4, as seen from a negative side of the Z axis.

FIGS. 7A to 7C illustrate an A1-part with enlarged scale of FIG. 5.

FIGS. 8A to 8C illustrate an A2-part with enlarged scale of FIG. 6.

FIG. 9 illustrates a fixing device, as seen from the positive side of the Z axis, of an image forming apparatus according to a second embodiment.

FIG. 10 illustrates a fixing device, as seen from the positive side of the Z axis, of an image forming apparatus according to a third embodiment.

FIGS. 11A and 11B illustrate an A1-part and an A2-part with enlarged scale of FIG. 10, respectively.

### DETAILED DESCRIPTION

### First Embodiment

A first embodiment according to the present disclosure will hereinafter be described with reference to the accompanying drawings. Elements that are the same or equivalent are labelled with the same reference signs in the drawings and description thereof is not repeated. In the first embodiment, mutually perpendicular X, Y, and Z axes are depicted in the drawings. The Z axis is parallel to a vertical plane, while the X and Y axes are parallel to a horizontal plane.

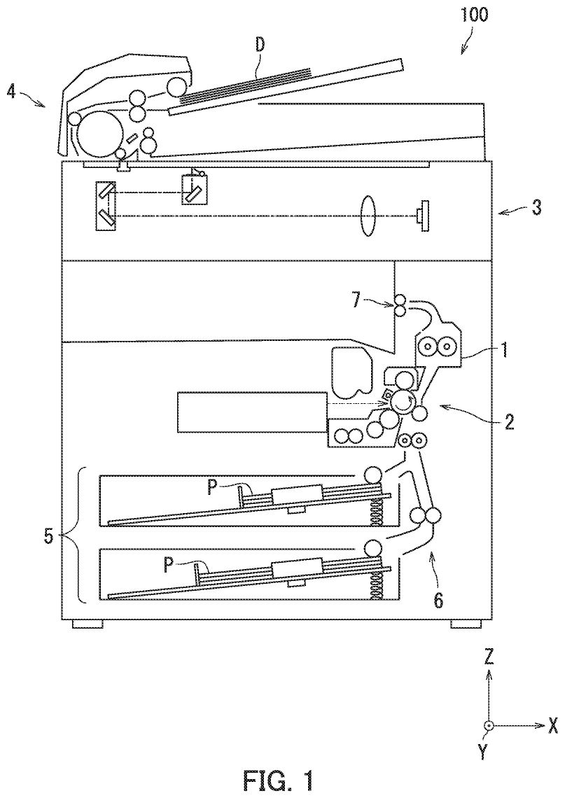

An image forming apparatus 100 according to the first embodiment of the present disclosure will be described with reference to FIG. 1. FIG. 1 illustrates the image forming apparatus 100 according to the first embodiment of the present disclosure. Examples of the image forming apparatus 100 include a copier, a facsimile machine, and a multifunction peripheral with those functions. The image forming apparatus 100 according to the first embodiment is a monochrome multifunction peripheral.

As illustrated in FIG. 1, the image forming apparatus 100 includes a fixing device 1, an image forming section 2, a reading section 3, a document conveyance section 4, a paper feed section 5, a conveyance section 6, and an ejection section 7.

The reading section 3 reads an image of a document D. The reading section 3 generates image data from the read image. The document conveyance section 4 conveys the document D to the reading section 3. The paper feed section 5 accommodates sheets of paper P and feeds the paper P to the conveyance section 6 one piece at a time. The paper P is one example of a recording medium. For example, the recording medium is made from synthetic resin or paper. The conveyance section 6 includes conveyance roller pairs and conveys the paper P to the ejection section 7 via the image forming section 2.

The image forming section 2 electrographically forms a toner image on the paper P based on the image data. The image data represents for example an image of the document D. The image forming section 2 includes for example an electro-photosensitive drum, a charger, a light exposure device, a development device, a replenishment device, a transfer roller, a cleaner, and a static eliminator.

The fixing device 1 applies heat and pressure to the toner image to fix the toner image to the paper P. The conveyance section 6 conveys, to the ejection section 7, the paper P to which the toner image has been fixed. The ejection section 7 ejects the paper P out of a housing of the image forming apparatus 100.

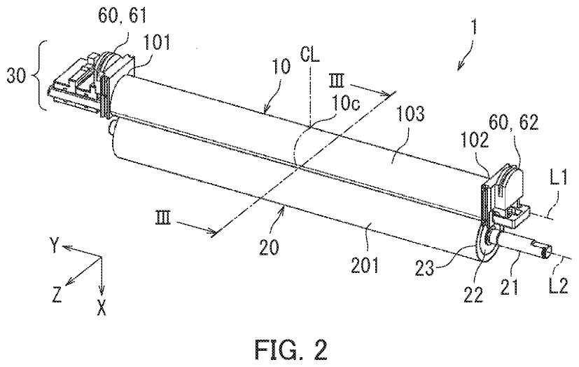

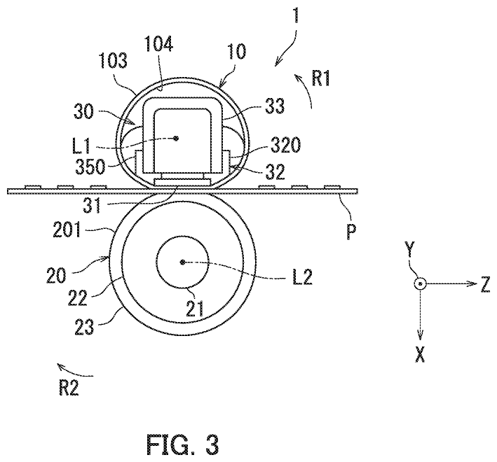

A configuration of the fixing device 1 according to the first embodiment will next be described in detail with reference to FIGS. 2 and 3. FIG. 2 is a perspective view of main parts of the fixing device 1 according to the first embodiment.

As illustrated in FIG. 2, the fixing device 1 includes a fixing belt 10, a pressure member 20, a heating section 30, and a belt holding member 60.

The fixing belt 10 heats the paper P to which the toner image has been transferred. The fixing belt 10 has an endless shape. The fixing belt 10 is substantially hollow cylindrical in shape. The fixing belt 10 is flexible. The fixing belt 10 is allowed to rotate around a first rotational axis L1 as an axial center. The fixing belt 10 extends in a direction of the first rotational axis L1. The fixing belt 10 includes a first end 101, a second end 102, and an outer circumferential surface 103. The first and second ends 101 and 102 are opposite ends of the fixing belt 10 in the direction of the first rotational axis L1. The direction of the first rotational axis L1 may hereinafter be referred to as a “rotational axis direction”, a “rotational axis direction of the fixing belt 10”, or a “width direction of the fixing belt 10”. In addition, a middle (center) 10c of the fixing belt 10 in the rotational axis direction may be referred to as a “middle 10c of the belt”. The middle 10c may be referred to as the “center 10c”. Moreover, an imaginary line crossing the middle 10c of the belt is referred to as a middle line CL. The middle line CL may be referred to as a “center line CL”.

The fixing belt 10 includes layers. The fixing belt 10 includes for example a polyimide layer and a releasing layer 23. The releasing layer 23 is formed on an outer circumferential surface of the polyimide layer. The releasing layer 23 is for example a heat resistant film made from fluororesin.

The pressure member 20 applies pressure to the outer circumferential surface 103 of the fixing belt 10, and also rotates the fixing belt 10. The pressure member 20, together with the fixing belt 10, applies pressure to the paper P to which the toner image has been transferred. Specifically, the pressure member 20 is substantially columnar in shape and placed facing the fixing belt 10. The pressure member 20 has an outer circumferential surface 201. The pressure member 20 presses the fixing belt 10. This causes the outer circumferential surface 201 of the pressure member 20 to be in contact with the outer circumferential surface 103 of the fixing belt 10, thereby forming a fixing nip.

The pressure member 20 is allowed to rotate on a second rotational axis L2. While the pressure member 20 is rotating, the fixing belt 10 rotates following the pressure member 20 being rotating. In other words, the pressure member 20 rotates the fixing belt 10. In the configuration, the toner image is fixed to the paper P as a result of the paper P passing through the fixing nip. Note that the paper P is conveyed in a paper conveyance direction (to a positive side of the Z axis). The pressure member 20 is for example a pressure roller. The pressure member 20 extends along the second rotational axis L2. Note that the second rotational axis L2 is substantially parallel to the first rotational axis L1.

The pressure member 20 includes a metal core 21 that is columnar, an elastic layer 22 that is hollow cylindrical, and a releasing layer 23. The elastic layer 22 is formed on the metal core 21. The releasing layer 23 is formed to cover a surface of the elastic layer 22. The metal core 21 is allowed to rotate on the second rotational axis L2. The metal core 21 is made from for example stainless steel or aluminum. The elastic layer 22 has elasticity and is made from for example silicone rubber. The releasing layer 23 is made from for example fluororesin.

The belt holding member 60 holds the ends of the fixing belt 10. The belt holding member 60 includes a first holding member 61 and a second holding member 62. The first holding member 61 holds the first end 101 of the fixing belt 10. The second holding member 62 holds the second end 102 of the fixing belt 10.

FIG. 3 is a sectional view of the fixing device 1 taken along a line III-III of FIG. 2. Note that the belt holding member 60 and part of elements inside the fixing belt 10 are omitted in FIG. 3 for easy understanding.

As illustrated in FIG. 3, the fixing belt 10 further has an inner circumferential surface 104. The inner circumferential surface 104 of the fixing belt 10 faces the heating section 30. In other words, the heating section 30 is placed inside the fixing belt 10, and faces the inner circumferential surface 104 of the fixing belt 10. The heating section 30 includes a heater 31, a heater holding member 32, and a reinforcing member 33.

The heater 31 heats the fixing belt 10. The heater 31 extends along the first rotational axis L1. Examples of the heater 31 include a surface heater and a long thin plate heater. The heater 31 is for example a ceramic heater and includes a ceramic substrate and a resistance heating element. The heater 31 is for example 1 mm in thickness. The heater 31 receives pressure from the pressure member 20 through the fixing belt 10. The heater 31 receives pressure from the reinforcing member 33 through the heater holding member 32.

The heater holding member 32 holds the heater 31. The heater holding member 32 and the fixing belt 10 are located on opposite sides of the heater 31. The heater holding member 32 is placed inside the fixing belt 10 on the side nearer the pressure member 20 than the first rotational axis L1. The heater holding member 32 is for example made from heat resistant resin. The heater holding member 32 extends along the first rotational axis L1. One of two ends of the heater holding member 32 in the direction of the first rotational axis L1 is allowed to engage with for example a connector located at a main body of the image forming apparatus 100.

The heater holding member 32 has a first side surface 320 and a second side surface 350. The first side surface 320 is a side surface of the heater holding member 32 on the positive side of the Z axis. The second side surface 350 is a side surface of the heater holding member 32 on a negative side of the Z axis. Part of the inner circumferential surface 104 is in contact with the first and second side surfaces 320 and 350. The part of the inner circumferential surface 104 is contact with part or all of the first and second side surfaces 320 and 350.

The reinforcing member 33 reinforces the heater holding member 32. The reinforcing member 33 is for example a long thin metal frame stay member. The reinforcing member 33 has a substantially inverted U-shape in a sectional view in a direction along the first rotational axis L1. The reinforcing member 33 extends along the first rotational axis L1. The reinforcing member 33 faces the heater holding member 32. The reinforcing member 33 and the heater 31 are located on opposite sides of the heater holding member 32. The heater holding member 32 is supported by the belt holding member 60.

The fixing belt 10 rotates in a first rotational direction R1, following the pressure member 20 rotating in a second rotational direction R2. Therefore, of the inner circumferential surface 104 of the fixing belt 10, part facing the first side surface 320 of the heater holding member 32 moves to a negative side of the X axis. In contrast, of the inner circumferential surface 104 of the fixing belt 10, part facing the second side surface 350 of the heater holding member 32 moves to a positive side of the X axis.

Lubricating oil G is applied to an inside of the fixing belt 10. The lubricating oil G moves following the fixing belt 10 being rotating. Specifically, when the fixing belt 10 rotates in the first rotational direction R1, part of the lubricating oil G that is out of contact with the first and second side surfaces 320 and 350 moves toward the first or second end 101 or 102 described with reference to FIG. 2.

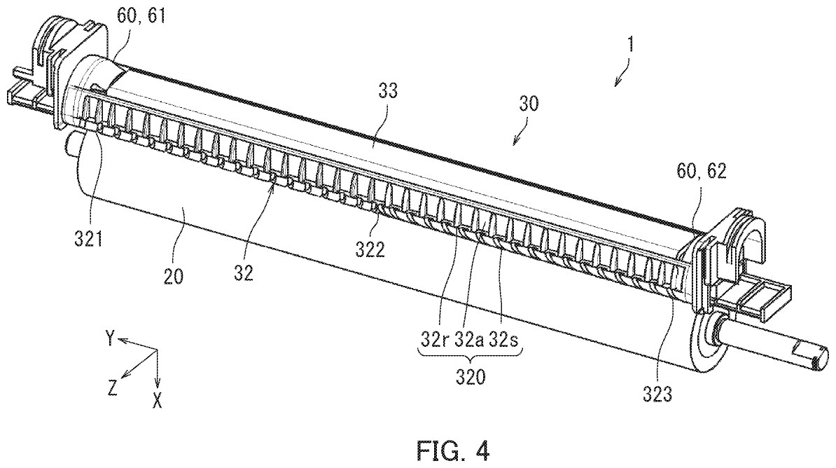

Next, the configuration of the heater holding member 32 in the first embodiment will further be described with reference to FIGS. 4 to 6. FIG. 4 is a perspective view of the fixing device 1 depicted in FIG. 2 with the fixing belt 10 omitted.

As illustrated in FIG. 4, the first side surface 320 has a first end 321, a middle 322, and a second end 323. The middle 322 may hereinafter be referred to as a “center 322”. The first and second ends 321 and 323 of the heater holding member 32 are opposite ends of the heater holding member 32 in a width direction thereof. The width direction of the heater holding member 32 corresponds to a Y-axis direction. The middle 322 is a middle (center) of the heater holding member 32 in the width direction thereof. The middle 322 is located on the middle line CL described with reference to FIG. 2. The first holding member 61 engages with the first end 321 of the heater holding member 32. The second holding member 62 engages with the second end 323 of the heater holding member 32.

The heater holding member 32 has a main body 32a, and also has ribs 32r and inclined slits 32s on a side of the first side surface 320. The present disclosure is not limited to the inclined slits 32s. This may be applied to the whole present disclosure. The ribs 32r are arranged at regular intervals in the Y-axis direction. The ribs 32r are not necessarily arranged at regular intervals. The Y-axis direction is the rotational axis direction (direction perpendicular to the rotational direction) of the fixing belt 10. The ribs 32r protrude from the main body 32a. The inclined slits 32s are recessed in the main body 32a.

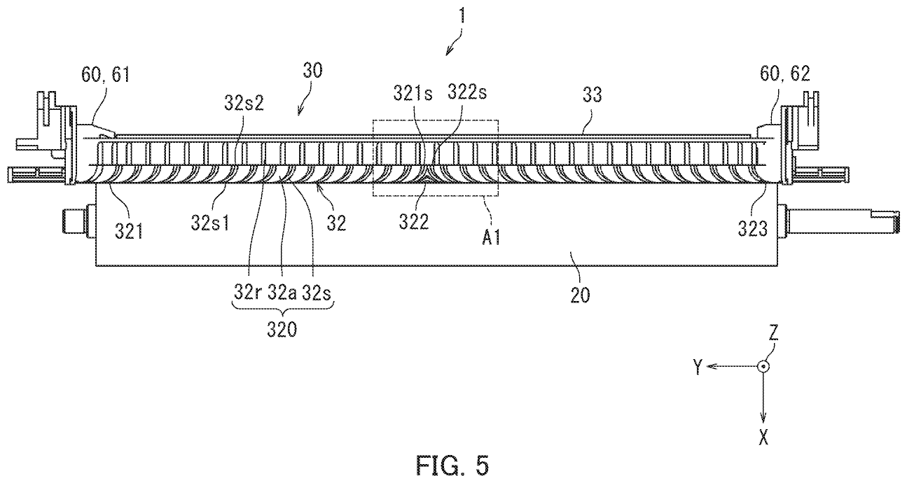

The inclined slits 32s will next be described with reference to FIGS. 3, 5, and 6. FIG. 5 is a view of the fixing device 1 depicted in FIG. 4, as seen from the positive side of the Z axis. Specifically, FIG. 5 is a view of the fixing device 1 as seen from the side of the first side surface 320 of the heater holding member 32.

As illustrated in FIG. 5, the inclined slits 32s are arranged in the direction of the first rotational axis L1 (direction perpendicular to the rotational direction) of the fixing belt 10. The inclined slits 32s are arranged in a symmetrical manner about the middle 322 of the heater holding member 32. Specifically, the inclined slits 32s are arranged in a line symmetrical manner about the middle line CL crossing the middle 10c of the fixing belt 10 (see FIG. 2).

The inclined slits 32s are arranged at regular intervals in the rotational axis direction (direction perpendicular to the rotational direction) of the fixing belt 10. The inclined slits 32s are not necessarily arranged at regular intervals. This may be applied to the whole present disclosure. The inclined slits 32s may be arranged in a symmetrical manner about the middle 322 of the heater holding member 32. Specifically, the inclined slits 32s may be arranged in a line symmetrical manner about the middle line CL crossing the middle 10c of the fixing belt 10 (see FIG. 2).

Inclined slits 32s located nearer the first end 321 than the middle 322 may hereinafter be referred to as a “first slit group”. In addition, inclined slits 32s located nearer the second end 323 than the middle 322 may hereinafter be referred to as a “second slit group”.

The heater holding member 32 has inclined slits 32s, or a first or second confluent slit 321s or 322s on the side of the first side surface 320. The first slit group includes the first confluent slit 321s. The second slit group includes the second confluent slit 322s. In the first embodiment, the first confluent slit 321s includes two inclined slits 32s. In addition, the second confluent slit 322s includes two inclined slits 32s.

The inclined slit 32s has one end 32s1 and the other end 32s2. That is, each of the inclined slits 32s has one end 32s1 and the other end 32s2. The one end 32s1 is located on a side of the pressure member 20. The other end 32s2 is an end of a corresponding inclined slit 32s on an opposite side to the pressure member 20 in the first rotational direction R1 of the fixing belt 10. The other end 32s2 of each inclined slit 32s is located nearer the middle 322 of the heater holding member 32 in the direction of the first rotational axis L1 than a corresponding one end 32s1. In other words, the other end 32s2 is located nearer the middle 10c of the fixing belt 10 in the width direction thereof than the corresponding one end 32s1. As described with reference to FIG. 3, the fixing belt 10 rotates in the first rotational direction R1. On the side of the first side surface 320 in FIG. 5, a downstream side in the first rotational direction R1 of the fixing belt 10 corresponds to an upper side in FIGS. 3 and 5. Each of the other ends 32s2 of the inclined slits 32s corresponding to the upper side extends toward the middle 10c of the fixing belt 10.

The two inclined slits 32s included in the first confluent slit 321s have respective other ends 32s2 whose locations differ from each other. Specifically, of the inclined slits 32s, the other end 32s2 of the inclined slit 32s located on the side of the first end 321 is farther from the pressure member 20 than the other end 32s2 of the inclined slit 32s located on the side of the middle 322.

The two inclined slits 32s included in the second confluent slit 322s have respective other ends 32s2 whose locations differ from each other. Specifically, of the inclined slits 32s, the other end 32s2 of the inclined slit 32s located on the side of the second end 323 is farther from the pressure member 20 than the other end 32s2 of the inclined slit 31s located on the side of the middle 322.

The inclined slits 32s include the first confluent slit 321s or the second confluent slit 322s. The first and second confluent slits 321s and 322s are arranged in the width direction of the fixing belt 10 (i.e., rotational axis direction of fixing belt 10) with the middle 322 of the heater holding member 32 interposed between the first and second confluent slits 321s and 322s. The first and second confluent slits 321s and 322s meet at the middle 322 of the heater holding member 32.

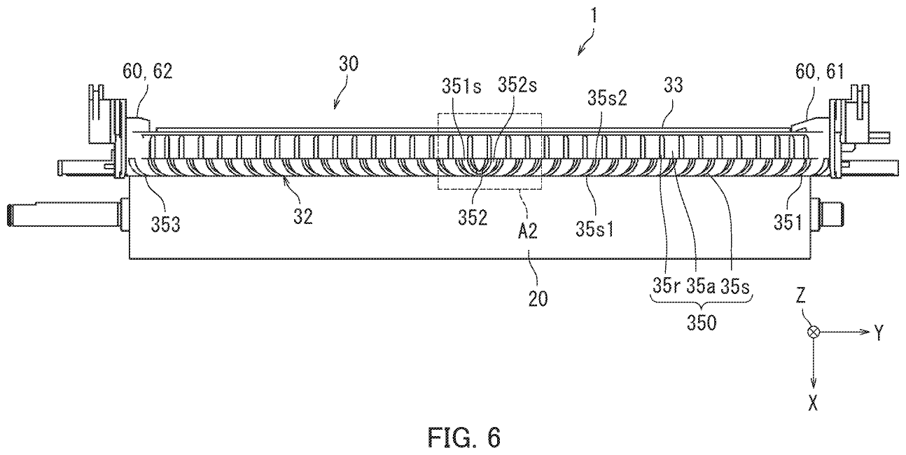

FIG. 6 is a view of the fixing device 1 depicted in FIG. 4, as seen from the negative side of the Z axis. Specifically, FIG. 6 is a view of the fixing device 1 as seen from the side of the second side surface 350 of the heater holding member 32.

As illustrated in FIG. 6, the second side surface 350 has a first end 351, a middle 352, and a second end 353. Like the first side surface 320, the heater holding member 32 having the main body 35a has ribs 35r and inclined slits 35s on the side of the second side surface 350. Like the ribs 32r, the ribs 35r are arranged at regular intervals in the rotational axis direction of the fixing belt 10. The ribs 35r are not necessarily arranged at regular intervals. The ribs 35r protrude from the main body 35a. The inclined slits 35s are recessed in the main body 35a. That is, each of the inclined slits 35s is recessed in the main body 35a.

The inclined slits 35s are arranged at regular intervals in the rotational axis direction of the fixing belt 10. The inclined slits 35s are not necessarily arranged at regular intervals. The inclined slits 35s are arranged in a symmetrical manner about the middle 352 of the heater holding member 32. Specifically, the inclined slits 35s are arranged in a line symmetrical manner about the middle line CL crossing the middle 10c of the fixing belt 10 (see FIG. 2).

Inclined slits 35s located nearer the first end 351 than the middle 352 may hereinafter be referred to as a “third slit group”. In addition, inclined slits 35s located nearer the second end 353 than the middle 352 may be referred to as a “fourth slit group”.

The heater holding member 32 has inclined slits 32s, or third or fourth confluent slit 351s or 352s on the side of the second side surface 350. The third slit group includes the third confluent slit 351s. The fourth slit group includes the fourth confluent slit 352s. In the present embodiment, the third confluent slit 351s includes two inclined slits 35s. In addition, the fourth confluent slit 352s includes two inclined slits 35s.

The inclined slit 35s has one end 35s1 and the other end 35s2. That is, each of the slits 35s includes one end 35s1 and the other end 35s2. The one end 35s1 of each slit 35s is an end of a corresponding slit 35s on the side of the pressure member 20. The other end 35s2 of each slit 35s is an end of the corresponding slit 35s on the opposite side to the pressure member 20. The one end 35s1 of each inclined slit 35s is located nearer the middle 352 of the heater holding member 35 than the corresponding other end 35s2.

In other words, the one end 35s1 is located nearer the middle 10c of the fixing belt 10 in the width direction thereof than the corresponding other end 35s2. As described with reference to FIG. 3, the fixing belt 10 rotates in the first rotational direction R1. On the side of the second side surface 350 in FIG. 6, a downstream side in the first rotational direction R1 of the fixing belt 10 corresponds to a lower side in FIGS. 3 and 6. Each of the one ends 35s1 of the inclined slits 35s corresponding to the lower side extends toward the middle 10c of the fixing belt 10.

The two inclined slits 35s included in the third confluent slit 351s have respective one ends 35s1 whose locations differ from each other. Specifically, of the inclined slit 35s, the one end 35s1 of the inclined slit 35s located on the side of the first end 351 is nearer the pressure member 20 than the one end 35s1 of the inclined slit 35s located on the side of the middle 352.

The two inclined slits 35s included in the fourth confluent slit 352s have respective one ends 35s1 whose locations differ from each other. Specifically, of the inclined slit 35s, the one end 35s1 of the inclined slit 35s located on the side of the second end 353 is nearer the pressure member 20 than the one end 35s1 of the inclined slit 35s located on the side of the middle 352.

The third and fourth confluent slits 351s and 352s are arranged in the width direction of the fixing belt 10 with the middle 352 of the heater holding member 32 interposed therebetween. The third and fourth confluent slits 351s and 352s meet at the middle 352 of the heater holding member 32.

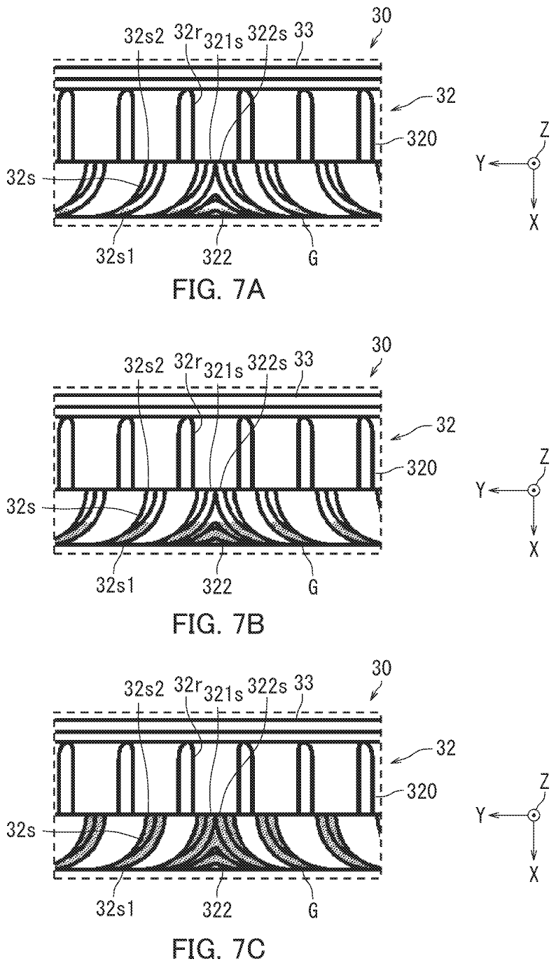

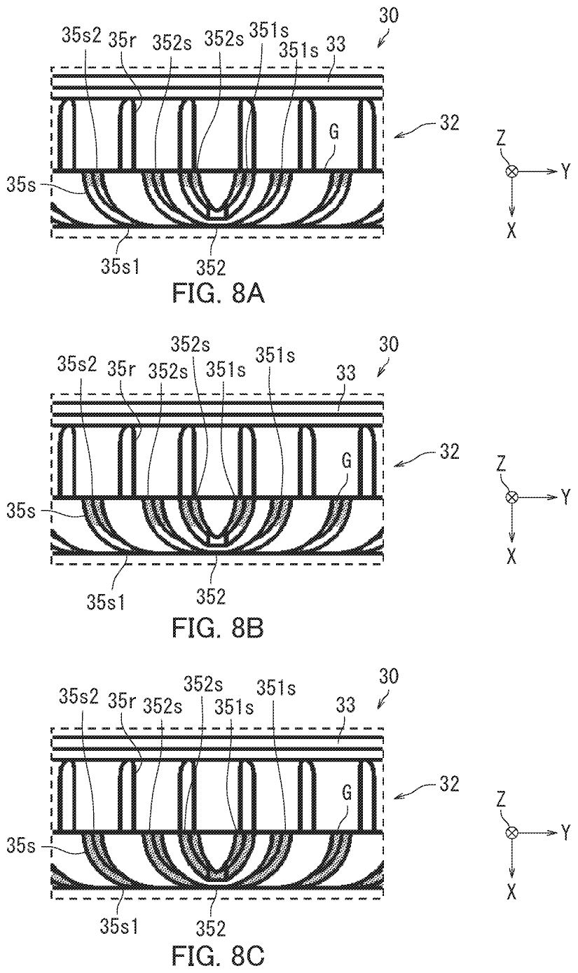

Next, a flow of the lubricating oil G in the present embodiment will further be described with reference to FIGS. 7A to 8C. FIGS. 7A to 7C illustrate an A1-part with enlarged scale of FIG. 5. Specifically, FIGS. 7A to 7C illustrate, in a time-sequence manner, the lubricating oil G on the first side surface 320 when the fixing belt 10 rotates.

FIG. 7A illustrates a state where the fixing belt 10 starts rotating. FIG. 7B illustrates a state where the fixing belt 10 rotates from the state of FIG. 7A. FIG. 7C illustrates a state where the fixing belt 10 still rotates after the state of FIG. 7B. The first rotational direction R1 in each of the states of FIGS. 7A to 7C corresponds to a negative X-axis direction.

When the fixing belt 10 starts rotating in the first rotational direction R1, the lubricating oil G starts moving from the side of the pressure member 20 to the negative side of the X axis as illustrated in FIG. 7A. The inner circumferential surface 104 of the fixing belt 10 is in close contact with the first side surface 320 of the heater holding member 32. The inclined slits 32s are recessed in the main body 32a. The lubricating oil G accordingly gathers in the inclined slits 32s and moves along the inclined slits 32s.

When the fixing belt 10 continues rotating, the lubricating oil G adheres to the inclined slits 32s from the negative side of the X axis and moves along the inclined slits 32s as illustrated in FIG. 7B. The other end 32s2 of each of the inclined slits 32s is located nearer the middle 322 than the one end 32s1 of a corresponding slit 32s. The lubricating oil G therefore moves toward the middle 322 from the sides of the first and second ends 321 and 323 of the first side surface 320 along the inclined slits 32s.

When the fixing belt 10 still continues rotating, the lubricating oil G reaches respective other ends 32s2 of the inclined slits 32s as illustrated in FIG. 7C. The lubricating oil G having reached the respective other ends 32s2 overflows from the respective other ends 32s2 of the inclined slits 32s. A junction of the first and second confluent slits 321s and 322s allows the lubricating oil G to stay there and easily overflow therefrom.

The lubricating oil G moves toward the middle 322 from the sides of the first and second ends 321 and 323 of the heater holding member 32 in an area where the inner circumferential surface 104 of the fixing belt 10 is in contact with the first side surface 320 of the heater holding member 32. As a result, the lubricating oil G reaches the junction of the first and second confluent slits 321s and 322s and overflows from the inclined slits 32s. The lubricating oil G having overflowed adheres to the inner circumferential surface 104 of the fixing belt 10.

When the fixing belt 10 rotates, the lubricating oil G flows toward the ends of the fixing belt 10 in an area where the fixing belt 10 is out of contact with the first side surface 320. In an area where the fixing belt 10 is in contact with the first side surface 320, the lubricating oil G is conveyed along the inclined slits 32s toward the middle 322 of the heater holding member 32 (the middle 10c of the fixing belt 10) and then adheres to an area on the side of the middle 10c of the fixing belt 10. The lubricating oil G is then conveyed in the rotational direction of the fixing belt 10. The above configuration therefore enables the lubricating oil G to circulate along the inner circumferential surface 104 of the fixing belt 10.

FIGS. 8A to 8C illustrate an A2-part with enlarged scale of FIG. 6. FIG. 8A illustrates a state where the fixing belt 10 starts rotating. FIG. 8B illustrates a state where the fixing belt 10 rotates from the state of FIG. 8A. FIG. 8C illustrates a state where the fixing belt 10 still rotates after the state of FIG. 8B. The first rotational direction R1 in each of the states of FIGS. 8A to 8C corresponds to a positive X-axis direction.

When the fixing belt 10 starts rotating in the first rotational direction R1, the lubricating oil G starts moving from the side of the pressure member 20 to the positive side of the X axis as illustrated in FIG. 8A. The inner circumferential surface 104 of the fixing belt 10 is in close contact with the second side surface 350 of the heater holding member 32. In addition, the inclined slits 35s are recessed in the main body 32a. The lubricating oil G therefore gathers in the inclined slits 35s and moves along the inclined slits 35s.

When the fixing belt 10 continues rotating, the lubricating oil G adheres to the inclined slits 35s from the positive side of the X axis and moves along the inclined slits 35s as illustrated in FIG. 8B. The one end 35s1 of each of the inclined slits 35s is located nearer the middle 352 than the other end 35s2 of a corresponding slit 35s. The lubricating oil G accordingly moves toward the middle 352 from the sides of the first and second ends 351 and 353 of the second side surface 350 along the slits 35s.

When the fixing belt 10 still continues rotating, the lubricating oil G reaches the respective one ends 35s1 of the inclined slits 35s as illustrated in FIG. 8C. The lubricating oil G having reached the respective one ends 35s1 overflows from the one ends 35s1 of the inclined slits 35s. A junction of the third and fourth confluent slits 351s and 352s allows the lubricating oil G to stay there and easily overflow therefrom.

The lubricating oil G moves toward the middle 322 from the sides of the first and second ends 351 and 353 of the heater holding member 32 in an area where the inner circumferential surface 104 of the fixing belt 10 is in contact with the second side surface 350 of the heater holding member 32. The lubricating oil G having overflowed adheres to the inner circumferential surface 104 of the fixing belt 10. As a result, the lubricating oil G reaches the junction of the third and fourth confluent slits 351s and 352s and overflows from the inclined slits 35s.

When the fixing belt 10 rotates, the lubricating oil G flows toward the ends of the fixing belt 10 in an area where the fixing belt 10 is out of contact with the second side surface 350. The lubricating oil G is conveyed along the inclined slits 35s toward the middle 352 of the heater holding member 32 (the middle 10c of the fixing belt 10) and then adheres to an area on the side of the middle 10c of the fixing belt 10. The lubricating oil G is then conveyed in the rotational direction of the fixing belt 10. The above configuration therefore enables the lubricating oil G to circulate along the inner circumferential surface 104 of the fixing belt 10.

Thus, when the fixing belt 10 rotates to be in contact with the first side surface 320, the lubricating oil G moves toward the middle 322 from the sides of the first and second ends 321 and 323 of the first side surface 320. In addition, when the fixing belt 10 rotates to be in contact with the second side surface 350, the lubricating oil G moves toward the middle 352 from the sides of the first and second ends 351 and 353 of the second side surface 350. The lubricating oil G having moved overflows from the inclined slits 32s and 35s to adhere to an area on the side of the middle 10c of the inner circumferential surface 104 of the fixing belt 10. The lubricating oil G is therefore prevented from easily flowing out of the ends of the fixing belt 10 even when the fixing belt 10 rotates.

The inclined slits 32s are arranged in a symmetrical manner about the middle 322 of the first side surface 320. In addition, the inclined slits 35s are arranged in a symmetrical manner about the middle 352 of the second side surface 350. The lubricating oil G therefore adheres to the inner circumferential surface 104 of the fixing belt 10 without being biased toward one end of the heater holding member 32.

The present embodiment enables less outflow of the lubricating oil G from the fixing device 1.

The configuration according to the present embodiment enables less outflow of the lubricating oil G from the first and second ends 321 and 323 of the heater holding member 32.

In the present embodiment, when the fixing belt 10 rotates in the first rotational direction R1, the lubricating oil G moves toward the first end 101 or the second end 102 while part of the fixing belt 10 is at the nip part between the fixing belt 10 and the pressure member 20. While part of the fixing belt 10 passes through the nip part between the fixing belt 10 and the pressure member 20 to be in contact with the inclined slits 35s located on the side of the first end 101 or the side of the second end 102, the lubricating oil G moves toward the center 101c. Thus, the fixing device 1 enables preferable circulation of the lubricating oil G on the inner circumferential surface 104 of the fixing belt 10 while the fixing belt 10 is rotating.

In the present embodiment, the inclined slits 35s are arranged in a symmetrical manner about the middle 352 of the heater holding member 32. This enables the fixing device 1 to further preferably circulate the lubricating oil G along the inner circumferential surface 104 of the fixing belt 10.

In the present embodiment, the first confluent slit 321s, the second confluent slit 322s, the third confluent slit 351s, or the fourth confluent slit 352s is formed. Accordingly, the lubricating oil G collected though the first confluent slit 321s, the second confluent slit 322s, the third confluent slit 351s, or the fourth confluent slit 352s can be circulated again along the inner circumferential surface 104 of the fixing belt 10 while the fixing belt 10 is rotating in the first rotational direction R1.

The configuration according to the present embodiment enables re-circulation of the lubricating oil G along the inner circumferential surface 104 of the fixing belt 10 having passed through the heater holding member 32.

### Second Embodiment

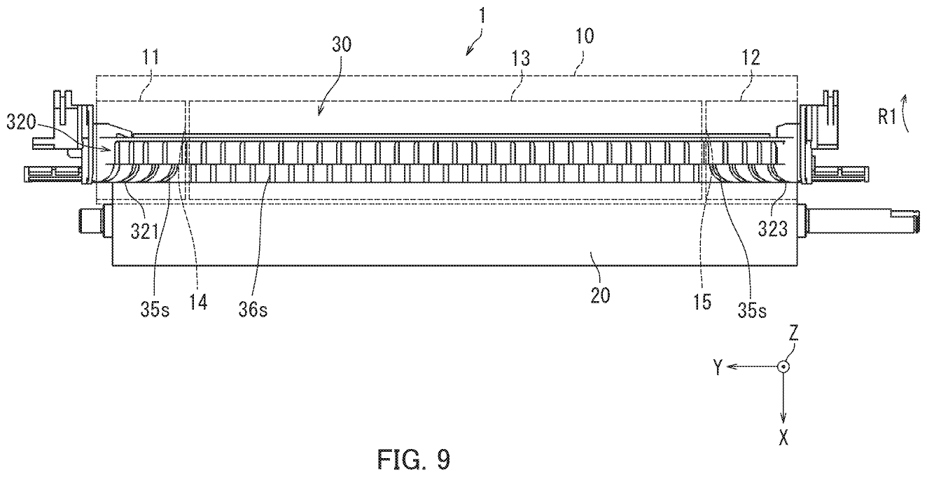

An image forming apparatus 100 according to a second embodiment will next be described with reference to FIG. 9 in addition to FIGS. 1 to 8C. FIG. 9 illustrates a fixing device 1, as seen from the positive side of the Z axis, of the image forming apparatus 100 according to the second embodiment.

In the second embodiment, inclined slits 35s are arranged in a first side surface 320 of a heater holding member 32 equipped for the fixing device 1 of the image forming apparatus 100. The inclined slits 35s are arranged in an end area (end area 11, end area 12) from an end (first end 321, first end 351, second end 353) to an intermediate part of the heater holding member 32 in a direction of a first rotational axis L1. Here, the intermediate part is from the end to a middle 10c of the heater holding member 32 in the direction of the first rotational axis L1.

As illustrated in FIG. 9, the fixing device 1 has the end area 11 and the end area 12. The end area 11 is an area to a boundary line 14 from the first end 321 of the heater holding member 32 equipped for the fixing device 1. Here, the boundary line 14 is between the first end 321 and the middle 10c. The end area 12 is an area to a boundary line 15 from the second end 323 of the heater holding member 32 equipped for the fixing device 1. Here, the boundary line 15 is between the second end 323 and the middle 10c.

A second side surface 350 of the heater holding member 32 equipped for the fixing device 1 of the image forming apparatus 100 has a configuration similar to that of the first side surface 320. An inclined slit 35s is located in an end area 11 of the second side surface 350.

More than one inclined slit 35s may be located in the end area 11 of the second side surface 350. Each inclined slit 35s may be the same as each inclined slit 35s described in the first embodiment.

An inclined slit 35s is formed in an end area 12 of the second side surface 350. More than one inclined slit 35s may be formed in the end area 12. Each inclined slit 35s may be the same as each inclined slit 35s described in the first embodiment.

In the present embodiment, the inclined slits 35s are located in each of the end area 11 of the first side surface 320 and the end area 12 of the second side surface 350, which the heater holding member 32 has. This enables suppression of outflow of lubricating oil G from the first end 321, the second end 323, the first end 351, and the second end 353 of the heater holding member 32.

In the present embodiment, it is possible to prevent a concentration of the lubricating oil G at the middle 10c of an inner circumferential surface 104 of the fixing belt 10 and to achieve uniform distribution of the lubricating oil G.

In the second embodiment, a non-inclined slit 36s is located in a middle area 13 other than the end areas 11 and 12.

The non-inclined slit 36s is almost parallel to a first rotational direction R1 of the fixing belt 10 or not inclined relative to the direction of the first rotational axis L1 of the fixing belt 10. More than one non-inclined slit 36s may be arranged in the middle area 13.

In the present embodiment, it is possible to prevent a concentration of the lubricating oil G at the middle 10c of the inner circumferential surface 104 of the fixing belt 10 and to achieve uniform distribution of the lubricating oil G.

### Third Embodiment

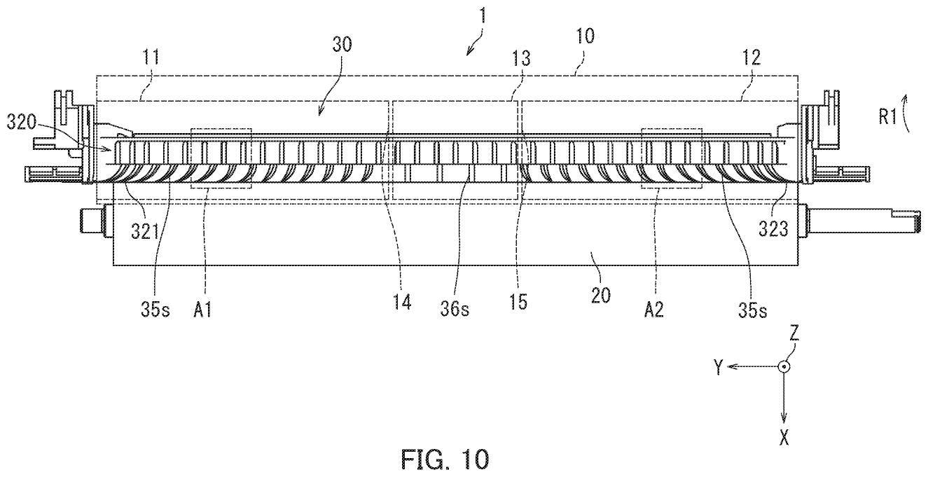

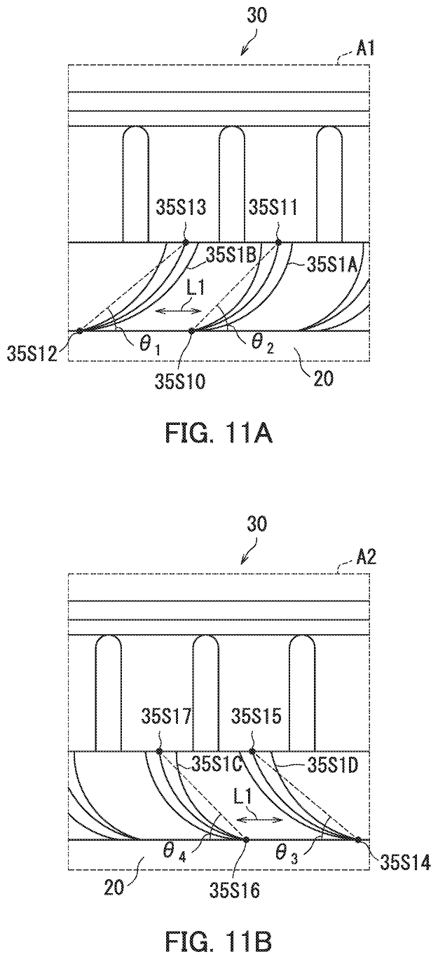

An image forming apparatus 100 according to a third embodiment will next be described with reference to FIGS. 10, 11A, an 11B in addition to FIGS. 1 to 8C. FIG. 10 illustrates a fixing device 1, as seen from the positive side of the Z axis, of the image forming apparatus 100 according to the third embodiment. FIGS. 11A and 11B illustrate an A1-part and an A2-part with enlarged scale of FIG. 10, respectively.

In the fixing device 1 of the image forming apparatus 100 according to the third embodiment, respective inclination angles θ of inclined slits 35s, from an end (first end 321, first end 351, second end 323, second end 353) toward a middle 10c of the heater holding member 32 in a direction of a first rotational axis L1, relative to the first rotational axis L1 gradually increase.

As illustrated in FIG. 10, the fixing device 1 has an end area 11 and an end area 12. The end area 11 is an area to a boundary line 14 reaching the middle 10c of the fixing belt 10 (middle 322 of heater holding member 32) from the first end 321 on a side of a first side surface 320 of the heater holding member 32. The end area 12 is an area to a boundary line 15 reaching the middle 10c (middle 322) from the second end 323 on the side of the first side surface 320. Here, the middle area 13 depicted in FIG. 9 need not be provided. That is, the end area 11 and the end area 12 may adjoin each other.

In the end area 11 of the first side surface 320, respective inclination angles θ of inclined slits 35s, toward the middle 10c of the fixing belt 10 (middle 322) from the first end 321 of the heater holding member 32 in the direction of the first rotational axis L1, relative to the first rotational axis L1 gradually increase.

That is, as illustrated in FIG. 11A, an angle θ2 of an inclined slit 35s 1A relative to the direction of the first rotational axis L1 is larger than an angle θ1 of an inclined slit 35s1B relative to the direction of the first rotational axis L1.

Specifically, the angle θ2 of a line segment relative to the direction of the first rotational axis L1 is larger than the angle θ1 of a line segment relative to the direction of the first rotational axis L1. Here, the former line segment is a line segment connecting one end 35s10 of the inclined slit 35s1A on a side of a pressure member 20 and the other end 35s11 of the inclined slit 35s1A on an opposite side to the pressure member 20. The latter line segment is a line segment connecting one end 35s12 of the inclined slit 35s1B on the side of the pressure member 20 and the other end 35s13 of the inclined slit 35s1B on the opposite side to the pressure member 20.

As illustrated in FIG. 11B, an angle θ4 of an inclined slit 35s1C relative to the direction of the first rotational axis L1 is larger than an angle θ3 of an inclined slit 35s1D relative to the direction of the first rotational axis L1.

Specifically, the angle θ4 of a line segment relative to the direction of the first rotational axis L1 is larger than the angle θ3 of a line segment relative to the direction of the first rotational axis L1. Here, the former line segment is a line segment connecting one end 35s16 of the inclined slit 35s1C on the side of the pressure member 20 and the other end 35s17 of the inclined slit 35s1C on the opposite side to the pressure member 20. The latter line segment is a line segment connecting one end 35s14 of the inclined slit 35s1D on the side of the pressure member 20 and the other end 35s15 of the inclined slit 35s1D on the opposite side to the pressure member 20.

In the end area 12 of the first side surface 320, respective inclination angles θ of inclined slits 35s, toward the middle 10c of the fixing belt 10 (middle 322) from the second end 323 of the heater holding member 32 in the direction of the first rotational axis L1, relative to the first rotational axis L1 gradually increase.

The second side surface 350 of the heater holding member 32 equipped for the fixing device 1 of the image forming apparatus 100 has a similar configuration to that of the first side surface 320.

The fixing device 1 has an end area 11 and an end area 12. The end area 11 is an area to a boundary line 14 reaching the middle 10c of the fixing belt 10 (middle 322) from the first end 351 of the heater holding member 32 on the side of the second side surface 350. The end area 12 is an area to a boundary line 15 reaching the middle 10c (middle 322) from the second end 353 of the heater holding member 32 on the side of the second side surface 350.

The inclined slit 35s is located in the end area 11 of the second side surface 350. More than one inclined slit 35s may be arranged in the end area 11. Each inclined slit 35s may be the same as each inclined slit 35s described in the second embodiment.

Respective inclination angles θ of inclined slits 35s, toward the middle 10c of the fixing belt 10 (middle 322) from the first end 351 of the heater holding member 32 in the direction of the first rotational axis L1, relative to the first rotational axis L1 gradually increase.

The inclined slit 35s is located in the end area 12 of the second side surface 350. More than one inclined slit 35s may be arranged in the end area 12. Each inclined slit 35s may be the same as each inclined slit 35s described in the second embodiment.

Respective inclination angles θ of incline slits 35s, toward the middle 10c of the fixing belt 10 (middle 322) from the first end 351 of the heater holding member 32 in the direction of the first rotational axis L1, relative to the first rotational axis L1 gradually increase.

In the present embodiment, it is possible to prevent the lubricating oil G collected though the inclined slits 35s from being excessively resupplied to the middle 10c of the fixing belt 10 and to achieve uniform distribution of the lubricating oil G in the fixing belt 10.

In the fixing device 1 of the image forming apparatus 100 according to the third embodiment, at least two non-inclined slits 36s are arranged with the middle 10c in the direction of the first rotational axis L1 interposed therebetween.

The fixing device 1 has the end area 11 and the end area 12. The end area 11 is an area to the boundary line 14 reaching the middle 10c of the fixing belt 10 (middle 322) from the first end 321 of the heater holding member 32, equipped for the fixing device 1, on the side of the first side surface 320. The end area 12 is an area to the boundary line 15 reaching the middle 10c (middle 322) from the second end 323 of the heater holding member 32, equipped for the fixing device 1, on the side of the first side surface 320. As described with reference to FIG. 9, the middle area 13 is interposed between the end area 11 and the end area 12.

In the end area 11 of the first side surface 320, the respective inclination angles θ of the inclined slits 35s, toward the middle 10c of the fixing belt 10 (middle 322) from the first end 321 of the heater holding member 32 in the direction of the first rotational axis L1, relative to the first rotational axis L1 gradually increase.

In the end area 12 of the first side surface 320, the respective inclination angles θ of the inclined slits 35s, toward the middle 10c of the fixing belt 10 (middle 322) from the second end 323 of the heater holding member 32 in the direction of the first rotational axis L1, relative to the first rotational axis L1 gradually increase.

In the middle area 13 of the first side surface 320, at least two non-inclined slits 36s are arranged with the middle 10c in the direction of the first rotational axis L1 interposed therebetween. Three or more non-inclined slits 36s may be arranged with the middle 10c in the direction of the first rotational axis L1 interposed therebetween.

The second side surface 350 of the heater holding member 32 equipped for the fixing device 1 of the image forming apparatus 100 has a similar configuration to that of the first side surface 320.

The fixing device 1 has the end area 11 and the end area 12. The end area 11 is an area to the boundary line 14 reaching the middle 10c of the fixing belt 10 (middle 322) from the first end 351 of the heater holding member 32, equipped for the fixing device 1, on the side of the second side surface 350. The end area 12 is an area to the boundary line 15 reaching the middle 10c of the fixing belt 10 (middle 322) from the second end 353 of the heater holding member 32, equipped for the fixing device 1, on the side of the second side surface 350.

The inclined slit 35s is located in the end area 11 of the second side surface 350. More than one inclined slit 35s may be arranged in the end area 12. Each inclined slit 35s may be the same as each inclined slit 35s described in the second embodiment 2.

The respective inclination angels θ of the inclined slits 35s, toward the middle 10c of the fixing belt 10 (middle 322) from the first end 351 of the heater holding member 32 in the direction of the first rotational axis L1, relative to the first rotational axis L1 gradually increase.

The inclined slit 35s is located in the end area 12 of the second side surface 350. More than one inclined slit 35s may be arranged in the end area 12. Each inclined slit 35s is the same as each inclined slit 35s described in the second embodiment.

The respective inclination angles θ of the inclined slits 35s, toward the middle 10c of the fixing belt 10 (middle 322) from the first end 351 of the heater holding member 32 in the direction of the first rotational axis L1, relative to the first rotational axis L1 gradually increase.

At least two non-inclined slits 36s are arranged in the middle area 13 of the second side surface 350 with the middle 10c in the direction of the first rotational axis L1 interposed therebetween. Three or more non-inclined slits 36s may be arranged with the middle 10c in the direction of the first rotational axis L1 interposed therebetween.

In the present embodiment, it is possible to prevent the lubricating oil G having retrieved though the inclined slits 35s from being excessively resupplied to the middle 10c of the fixing belt 10 and to achieve uniform distribution of the lubricating oil G in the fixing belt 10.

As above, the embodiments of the present disclosure have been described with reference to the drawings. However, the present disclosure is not limited to the above-described embodiment and can be practiced in various ways within the scope without departing from the essence of the present disclosure (see (1) and (2) below). The drawings mainly illustrate schematic constituent elements in order to facilitate understanding of the disclosure, and properties such as thickness, length, numbers or the like of constituent elements illustrated in the drawings may differ from actual properties thereof in order to facilitate preparation of the drawings. Further, the material, shape, dimensions, and the like of each constituent element described in the above embodiment are merely examples that do not impose any particular limitations and may be altered in various ways as long as such alterations do not substantially deviate from the effects of the present disclosure.

(1) Although the image forming apparatus 100 according to the embodiments of the present disclosure is a monochrome multifunction peripheral as described with reference to FIGS. 1 to 11, the present disclosure is not limited to this. For example, the image forming apparatus 100 may be a monochrome printer. Alternatively, the image forming apparatus 100 may be a color multifunction peripheral or a color printer.

(2) Although slits are provided in each of the main bodies 32a and 35a on the respective sides of the first and second side surfaces 320 and 350 in the embodiments of the present disclosure, the present disclosure is not limited to this. For example, slits may be provided in only one of main bodies 32a and 35a on the sides of the first side surface 320 and the side of the second side surface 350.

What is claimed is:

1. Fixing device comprising:
a fixing belt;
a pressure member configured to rotate the fixing belt while applying pressure to an outer circumferential surface of the fixing belt; and
a heating section that faces an inner circumferential surface of the fixing belt, wherein
the heating section includes
a heater configured to heat the fixing belt, and
a heater holding member that holds the heater,
the heater holding member has a first side surface, a second side surface, and an inclined slit, the first and second side surfaces being in contact with the inner circumferential surface, the inclined slit being located in at least one of the first and second side surfaces in a direction of a rotational axis of the fixing belt,
the inclined slit has one end on a side of the pressure member and an other end on an opposite side to the side of the pressure member, and
the other end is located nearer a middle of the fixing belt in the direction of the rotational axis than the one end.

2. The fixing device according to claim 1, wherein
the heater holding member has, as the inclined slit, inclined slits that are arranged in a symmetrical manner about the middle in the direction of the rotational axis.

3. The fixing device according to claim 1, wherein
the heater holding member has, as the inclined slit, two inclined slits between which the middle in the direction of the rotational axis is interposed, either respective one ends or respective other ends of the two inclined slits meeting at the middle.

4. The fixing device according to claim 1, wherein
the inclined slit is located in each of the first and second side surfaces.

5. The fixing device according to claim 1, wherein
the inclined slit is located in an end area to an intermediate part reaching the middle from an end of the heater holding member in the direction of the rotational axis.

6. The fixing device according to claim 5, wherein
the heater holding member has a non-inclined slit that is located in a middle area other than the end area of the at least one of the first and second side surfaces in the direction of the rotational axis.

7. The fixing device according to claim 1, wherein
the heater holding member has, as the inclined slit, inclined slits, respective inclination angles of the inclined slits toward the middle from an end of the heater holding member in the direction of the rotational axis, relative to the rotational axis gradually increase.

8. The fixing device according to claim 7, wherein
the heater holding member has at least two non-inclined slits between which the middle in the direction of the rotational axis is interposed.

9. An image forming apparatus comprising
the fixing device according to claim 1, and
an image forming section configured to form a toner image on a recording medium, wherein
the fixing device fixes the toner image to the recording medium.
